(19) United States
(12) Patent Application Publication
(10) Pub. No.: US 2024/0278242 A1
(43) Pub. Date: Aug. 22, 2024

(54) MATERIAL DEPOSITION ONTO AND RECOVERY FROM SURFACES VIA CONTACTLESS, REVERSIBLE DROPLET WETTING/DE-WETTING BY DIELECTRIC CHARGE INJECTION

(71) Applicant: THE TRUSTEES OF THE UNIVERSITY OF PENNSYLVANIA, Philadelphia, PA (US)

(72) Inventors: Daeyeon LEE, Wynnewood, PA (US); Junhyong KIM, Narberth, PA (US); Paradorn RUMMANEETHORN, Philadelphia, PA (US)

(21) Appl. No.: 18/570,153

(22) PCT Filed: Jun. 14, 2022
(86) PCT No.: PCT/US2022/072940

§ 371 Date: Dec. 14, 2023

Related U.S. Application Data
(60) Provisional application No. 63/210,135, filed on Jun. 14, 2021.

(51) Int. Cl. B01L 3/00

(52) U.S. Cl. CPC B01L 3/502792; B01L 2300/0645; B01L 2300/16; B01L 2400/0424

(57) ABSTRACT

Here we demonstrate a contactless method to induce reversible droplet contact angle modulation on chemically inert substrates via corona discharge-based dielectric charge injection (DCI). The method involves a probe that can induce dielectric breakdown of the surrounding dielectric medium, such as air, under voltages exceeding the medium's dielectric strength. Breakdown leads to ionization of the dielectric, after which then the ions accelerate away from the sharp tip due to electrostatic repulsion, resulting in charge injection onto a target surface. With DCI, one induces wetting of a water droplet on non-wetting, non-contacting surfaces in non-polar continuous phases. DCI can achieve up to 140° contact angle modulation. Furthermore, upon removal of the voltage, the droplet dewets and returns to the initial non-wetting state. DCI can induce deposition of encapsulated materials from droplets to the non-wetting surface. DCI can also recover materials from such a surface.

### CROSS-REFERENCE TO RELATED APPLICATIONS

The present application claims priority to and the benefit of U.S. patent application No. 63/210,135, “Material Deposition Onto And Recovery From Surfaces Via Contactless, Reversible Droplet Wetting/De-Wetting by Dielectric Charge Injection” (filed Jun. 14, 2021), the entirety of which application is incorporated herein by reference for any and all purposes.

### GOVERNMENT RIGHTS

This invention was made with government support under HG010023 awarded by the National Institutes of Health. The government has certain rights in the invention.

### TECHNICAL FIELD

The present disclosure relates to the field of droplet electrowetting.

### BACKGROUND

Electrowetting (EW) and electrowetting-on-dielectric (EWOD) are two traditional methods for contact angle modulation. However, EW and EWOD require direct droplet contact with an electrode, which may be challenging and undesirable when dealing with electrically sensitive cargo in the droplet, with microscale droplets, or with a large number of droplets. Although contactless methods that apply external physical stimuli to alter surface wetting properties have been reported, the range of contact angle modulation remains limited.

Accordingly, there is a long-felt need in the art for improved contactless methods for modulating droplet wetting state, e.g., by modulating the droplet contact angles.

### SUMMARY

Electrowetting (EW) and electrowetting-on-dielectric (EWOD) are two traditional methods for contact angle modulation. However, EW and EWOD require direct droplet contact with an electrode, which may be challenging and undesirable when dealing with electrically sensitive cargo in the droplet or with microscale droplets. Although contactless methods that apply external physical stimuli to alter surface wetting properties have been reported, the range of contact angle modulation remains limited. Here we demonstrate a contactless method to induce reversible droplet contact angle modulation on chemically inert substrates via corona discharge-based dielectric charge injection (DCI). The method involves a sharp, conductive probe that can induce dielectric breakdown of the surrounding dielectric medium, such as air, under voltages exceeding the medium's dielectric strength. Breakdown leads to ionization of the dielectric, after which then the ions accelerate away from the sharp tip due to electrostatic repulsion, resulting in charge injection onto a target surface. With DCI, we induce wetting of a water droplet on non-wetting, non-contacting surfaces in non-polar continuous phases. DCI can achieve up to 140° contact angle modulation-competitive or even exceeding the capabilities of traditional EW and EWOD. Furthermore, upon removal of the voltage and/or probe, droplet undergoes dewetting and returns to the initial non-wetting state. We show that DCI can be used to induce deposition of encapsulated materials from droplets to the non-wetting surface. DCI can similarly be applied for recovery of materials from such a surface. DCI presents a unique strategy for contactless, reversible contact angle modulation that is simple and powerful, with a wide application space that remains to be explored, especially in contexts where EW and EWOD become inapplicable.

Here we demonstrate, inter alia, a contactless method to induce reversible droplet contact angle modulation on chemically inert substrates via corona discharge-based dielectric charge injection (DCI). The method can be effected by way of, e.g., a sharp, conductive probe that can induce dielectric breakdown of the surrounding dielectric medium (e.g., air) under voltages exceeding the medium's dielectric strength. Breakdown leads to ionization of the dielectric, after which then the ions accelerate away from the sharp tip due to electrostatic repulsion, resulting in charge injection onto a target surface. With DCI, we induce wetting of a water droplet on non-wetting, non-contacting surfaces in non-polar continuous phases. DCI can achieve up to 140° contact angle modulation—competitive or even exceeding the capabilities of traditional EW and EWOD. Furthermore, upon removal of the voltage and/or probe, droplet undergoes dewetting and returns to the initial non-wetting state. We show that DCI can be used to induce deposition of encapsulated materials from droplets to the non-wetting surface. DCI can similarly be applied for recovery of materials from such a surface. DCI presents a unique strategy for contactless, reversible contact angle modulation that is simple and powerful, with a wide application space that remains to be explored, especially in contexts where EW and EWOD become inapplicable. The disclosed technique also affords the ability to break down a thin oil film that may be present and that separates the droplet from substrate. For this and other reasons, the disclosed technology affords previously-unobtainable temporal control of droplet-surface material interchange, while also affording that control in a manner that does not require physical contact between a voltage probe and the droplet being processed.

In one aspect, the present disclosure provides methods of modulating the contact angle of a droplet, comprising: applying a voltage across a probe disposed in a first medium and a target electrode so as to give rise to ions in the first medium that are encouraged away from the probe and toward the target electrode, the probe being configured such that the probe does not physically contact the droplet, the droplet being disposed between (1) the probe and (2) a dielectric surface located between the probe and the target electrode, and the ions being effective to decrease a contact angle of the droplet relative to the surface.

In another aspect, the present disclosure provides a system, comprising: a probe; a voltage source, the voltage source being in electronic communication with the probe; a target electrode; a dielectric substrate disposed between the probe and the target electrode, the system being configured such that the voltage source is operable to give rise to ions in first medium surrounding the probe that are encouraged away from the probe and toward the target electrode while the probe is free of physical contact with a droplet that has a density and is disposed between (1) the probe and (2) the dielectric substrate, the system being further configured such that the ions are sufficient to effect a decrease in a contact angle of the droplet relative to the substrate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1B provide an illustration of (FIG. 1A) traditional electrowetting and (FIG. 1B) traditional electrowetting on dielectric methods.

FIGS. 2A-2B provide a schematic of a system according to the present disclosure (FIG. 2A) and a photograph of a system (FIG. 2B) according to the present disclosure. As shown in FIG. 2A, there is no physical contact with the water droplet.

FIG. 3 provides contact angle as a function of time for a droplet after probe voltage is reduced/turned off.

FIG. 4 provides example images and contact angle vs. time data for aqueous droplets processed according to the disclosed technology. As shown by the “Nonwetted” and “Highly wetted” images, the disclosed technology is effective on droplets of varying sizes.

FIG. 5 provides data showing that wetting effected by the application of a voltage across the probe and the target electrode is reversible by turning off the voltage and/or by applying a nonzero magnitude voltage below dielectric breakdown levels, wherein there is reduced or even no active charge injection.

FIG. 6 provides non-limiting conclusions, showing the applicability of the present technology to reversible droplet wetting, which wetting can be used to deposit material on a surface and also remove material from the surface.

FIG. 7 provides a Dielectric Charge Injection (DCI) system setup schematic for droplet wetting state modulation contactlessly. The oil depth and sharp tip positions are fixed.

FIGS. 8A-8B provide (FIG. 8A) endpoint images showcasing the capability of DCI to modulate a droplet's wetting from nonwetted to highly wetted. As shown in FIG. 8A, the droplet goes from a nonwetted to a highly wetted state by application of DCI. FIG. 8B provides an image from beneath the substrate (using an inverted microscope) showing the presence of a wetting ring (faint dashed yellow circle) indicating surface contact of the droplet after applying DCI. As shown by FIGS. 8A-8B, the disclosed technology can take a droplet that is initially not in appreciable contact with the substrate (FIG. 8A) and can then (as shown by FIG. 8B) effect wetting and contact by the droplet with the substrate.

FIGS. 9A-9B provides (FIG. 9A) Sequential voltage increment shows points of discontinuity to a new exponential decay at the new voltage level. (FIG. 9B) Single-voltage 3-hour saturation at 4, 4.5, and 5 kV show distinct kinetics and saturation contact angle unique to each voltage level. Interestingly, the time scale in which the system reaches the plateau is approximately similar across different voltage levels. FIG. 9A provides droplet behavior with serial variation in voltage; one can see the comparatively abrupt change at an increase from 4 kV to 4.5 kV; without being bound to any particular theory, 4 kV is an inception point where ion bombardment begins. FIG. 9B shows a distinct contact angle for each voltage.

FIG. 10 provides (Increasing) Contact angle-voltage relationship in DCI (contact angle after holding a voltage for 3 hours). For this system configuration, 4 kV marks the breakdown inception boundary; on the other end, 5 kV marks contact angle saturation, as increasing voltage to 5.5 kV no longer appreciably reduces the contact angle. (Decreasing) After wetting at 5.5 kV, the system is brought back to lower target voltage for investigating contact angle hysteresis. As the voltage deviates from the global contact angle saturation point, the hysteresis increases. Notably, the receding contact angle is typically greater than the advancing contact angle, wherever hysteresis is pronounced.

Without being bound to any particular theory or embodiment, one can observe comparatively larger variability at lower voltages than at higher voltages.

FIGS. 11A-11B show dewetting completely back to initial state by simply turning off the power source, i.e. applying 0V. As shown, the disclosed technology is reversible, as a wetted droplet returns to its unwetted state when the voltage is turned off.

Dashed lines indicate contact angle prior to wetting. (FIG. 11A) Wetting ring analysis showing wetting ring (faint dashed yellow circle) at the beginning of dewetting, and the absence of wetting ring at the terminal time point indicating complete return to initial, nonwetted state. FIG. 11A shows the recovery of original contact angle after the voltage is switched off.

FIGS. 12A-12B provide applications of DCI towards two key modes of droplet-surface material interchange. (FIG. 12A) Material deposition: droplet containing fluorescent bovine serum albumin (fBSA) is wetted on the PDMS surface by DCI to initiate contact and deposition. A defined wetting area is formed that emits a fluorescence signal from the deposited material. Scar bar: 150 μm. (FIG. 12B) Material recovery: a pure deionized water droplet wets a dusty surface by DCI to initiate recovery of the surface debris. The droplet is dewetted and can then be further processed. Scale bar: 1.50 mm.

FIG. 13 provides illustrative schemes of material deposition and removal. As shown in the top line of images, material can be recovered by effecting droplet wetting on a surface that has materials (e.g., dyes, reagents, nucleic acids) disposed thereon. The droplet can be wetted (or spread) so as to contact the materials and the subsume the materials within. As shown in the bottom line of images, a droplet can accommodate a reaction (i.e., acting as a reactor). The droplet can then be wetted to a surface, and the reaction product within the droplet can then interact with material that is present on the surface, which can, in some cases, give rise to a further reaction that produces a further product that is subsumed within the droplet. The droplet (which now contains the further product) can then be recovered, e.g., by dewetting the droplet from the surface by reducing the voltage applied across the probe and target electrode (not shown).

FIG. 14 shows that the disclosed technology can be used with microwell arrays, e.g., to effect wetting of one or more droplets within microwells. The wetting can be used to effect contact between the droplet and a material within the microwell. As an example, such a material can be a “barcode” (e.g., a nucleic acid sequence) that includes information about the location of the droplet (e.g., the microwell in which the droplet was disposed) and/or the composition of the droplet (e.g., the materials that were in the droplet, the materials that were in the microwell, the batch number of the droplet, and the like).

FIG. 15 provides exemplary images of spontaneous wetting transition in an array of microwells. The increase in occupied surface area and decrease in ‘dark’ areas is due to droplet curvature.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### FIGURES

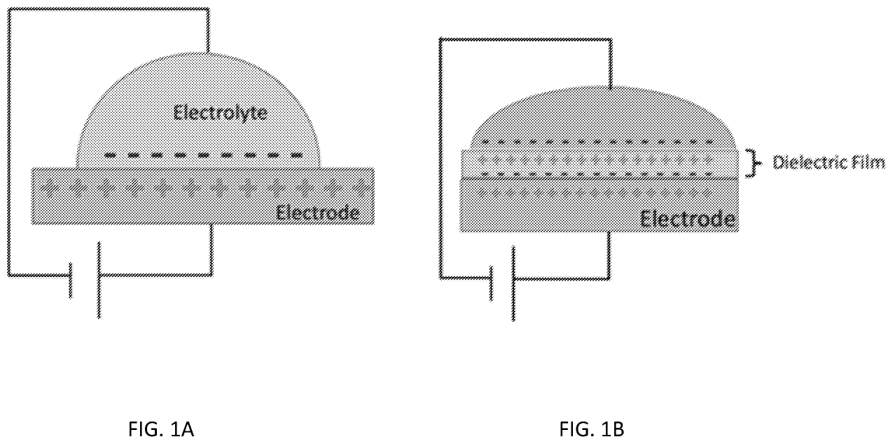

FIGS. 1A-1B provide an illustration of (FIG. 1A) traditional electrowetting and (FIG. 1B) traditional electrowetting on dielectric methods.

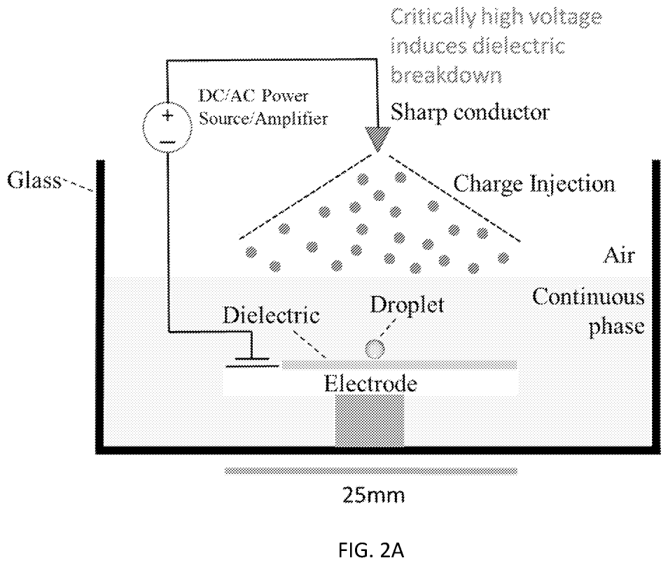

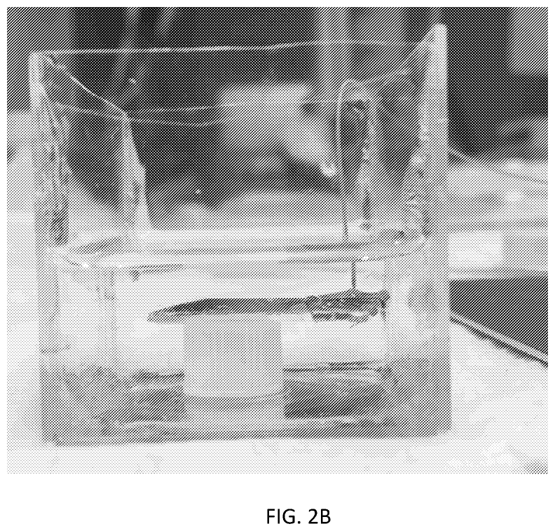

FIGS. 2A-2B provide a schematic of a system according to the present disclosure (FIG. 2A) and a photograph of a system (FIG. 2B) according to the present disclosure. As shown in FIG. 2A, there is no physical contact with the water droplet.

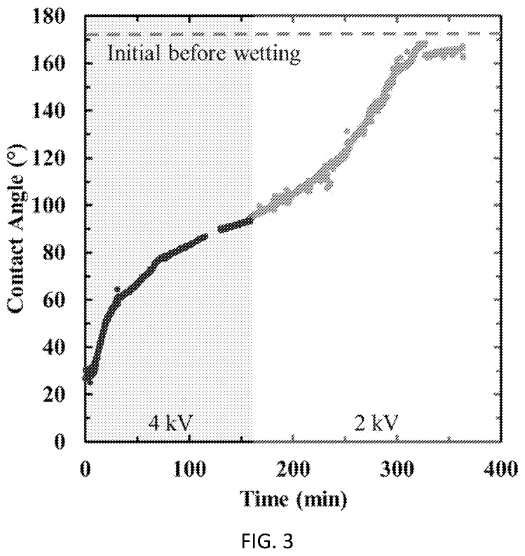

FIG. 3 provides contact angle as a function of time for a droplet after probe voltage is reduced/turned off.

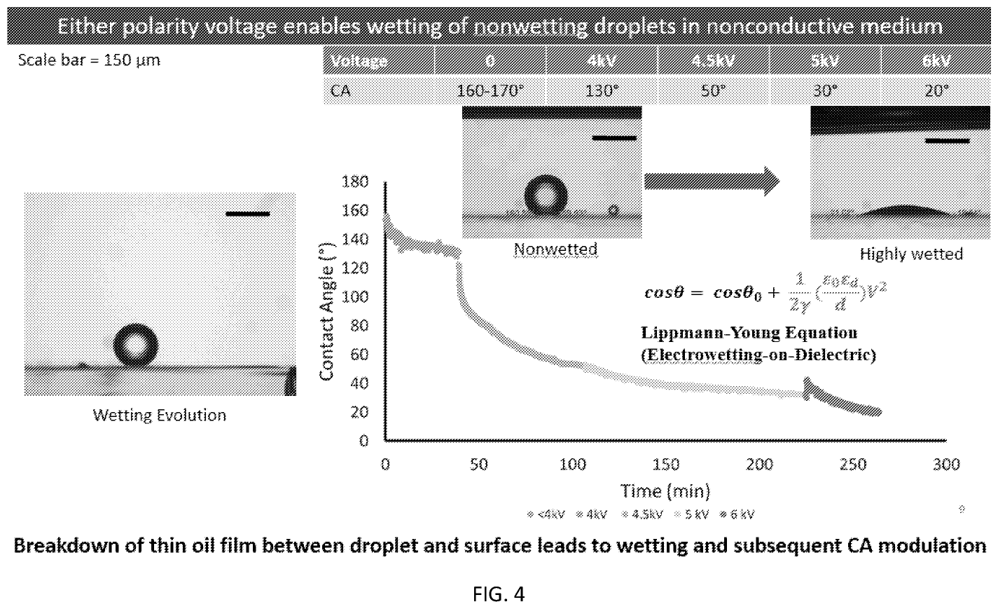

FIG. 4 provides example images and contact angle vs. time data for aqueous droplets processed according to the disclosed technology. As shown by the “Nonwetted” and “Highly wetted” images, the disclosed technology is effective on droplets of varying sizes.

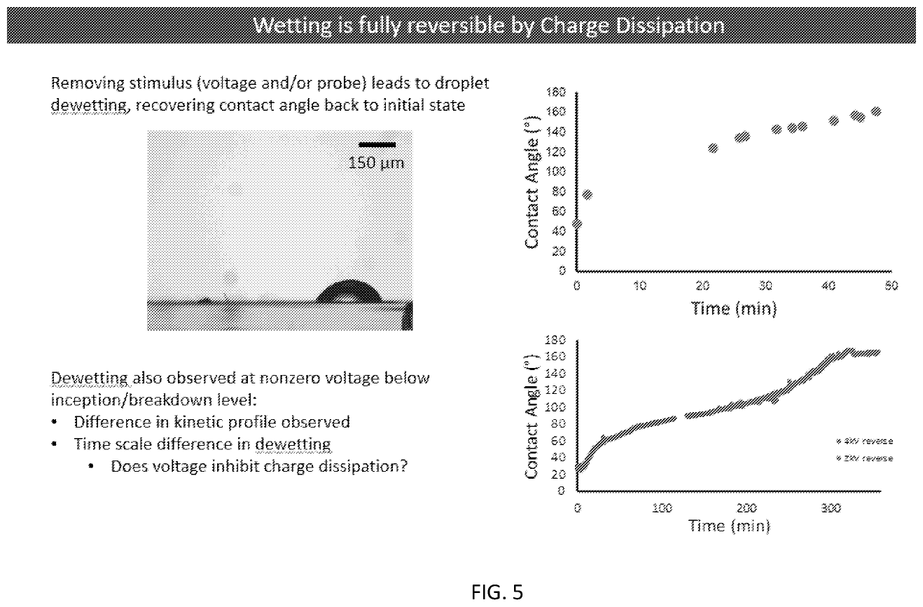

FIG. 5 provides data showing that wetting effected by the application of a voltage across the probe and the target electrode is reversible by turning off the voltage and/or by applying a nonzero magnitude voltage below dielectric breakdown levels, wherein there is reduced or even no active charge injection.

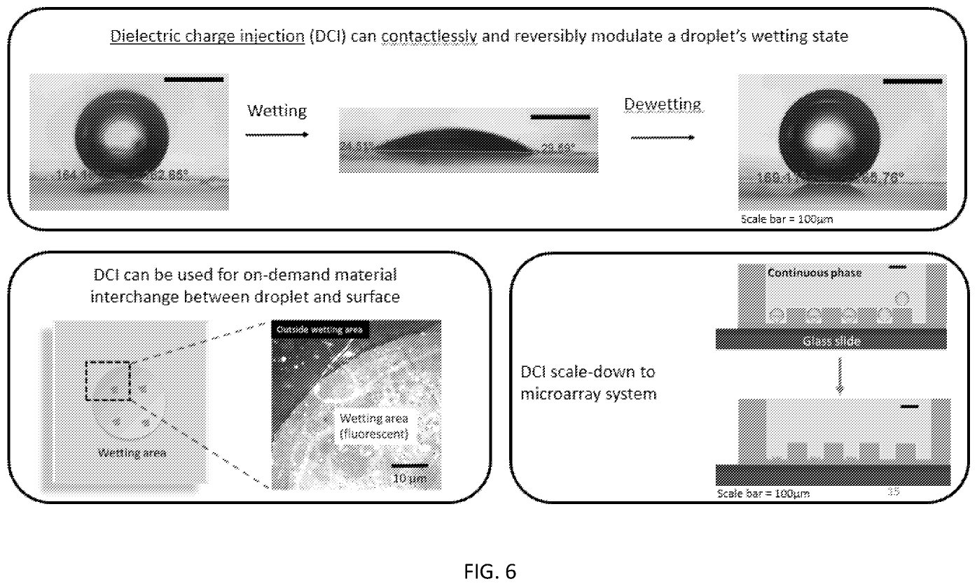

FIG. 6 provides non-limiting conclusions, showing the applicability of the present technology to reversible droplet wetting, which wetting can be used to deposit material on a surface and also remove material from the surface.

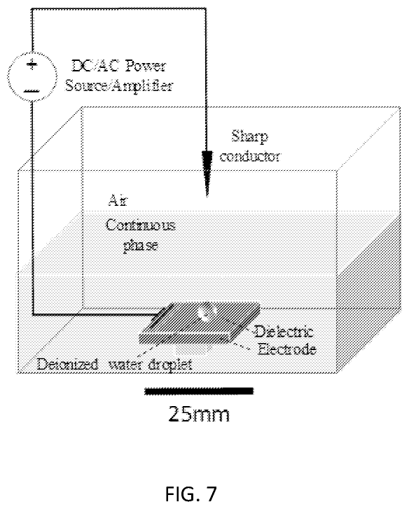

FIG. 7 provides a Dielectric Charge Injection (DCI) system setup schematic for droplet wetting state modulation contactlessly. The oil depth and sharp tip positions are fixed.

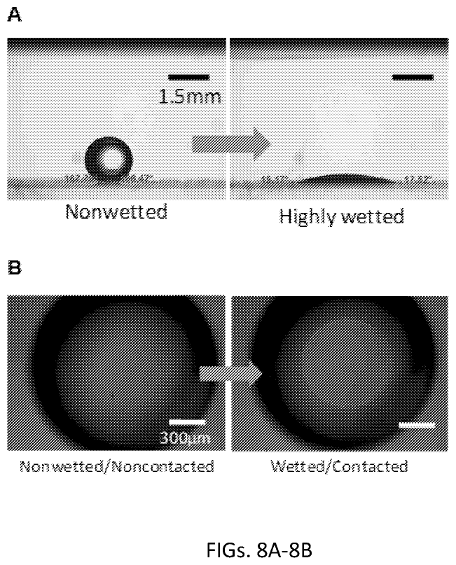

FIGS. 8A-8B provide (FIG. 8A) endpoint images showcasing the capability of DCI to modulate a droplet's wetting from nonwetted to highly wetted. As shown in FIG. 8A, the droplet goes from a nonwetted to a highly wetted state by application of DCI. FIG. 8B provides an image from beneath the substrate (using an inverted microscope) showing the presence of a wetting ring (faint dashed yellow circle) indicating surface contact of the droplet after applying DCI. As shown by FIGS. 8A-8B, the disclosed technology can take a droplet that is initially not in appreciable contact with the substrate (FIG. 8A) and can then (as shown by FIG. 8B) effect wetting and contact by the droplet with the substrate.

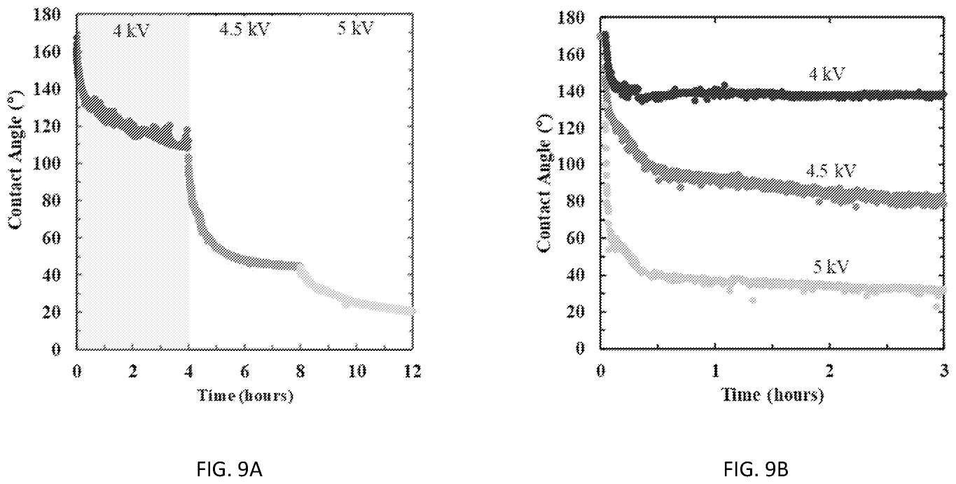

FIGS. 9A-9B provides (FIG. 9A) Sequential voltage increment shows points of discontinuity to a new exponential decay at the new voltage level. (FIG. 9B) Single-voltage 3-hour saturation at 4, 4.5, and 5 kV show distinct kinetics and saturation contact angle unique to each voltage level. Interestingly, the time scale in which the system reaches the plateau is approximately similar across different voltage levels. FIG. 9A provides droplet behavior with serial variation in voltage; one can see the comparatively abrupt change at an increase from 4 kV to 4.5 kV; without being bound to any particular theory, 4 kV is an inception point where ion bombardment begins. FIG. 9B shows a distinct contact angle for each voltage.

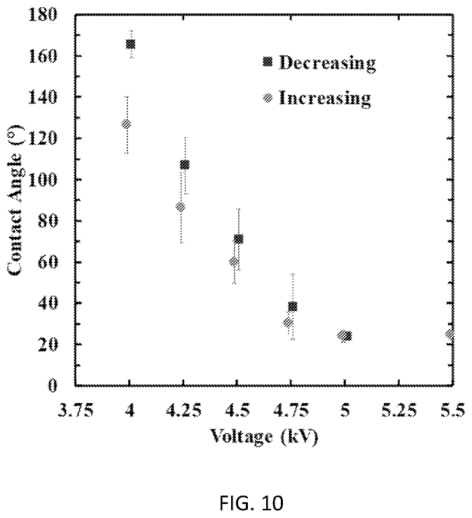

FIG. 10 provides (Increasing) Contact angle-voltage relationship in DCI (contact angle after holding a voltage for 3 hours). For this system configuration, 4 kV marks the breakdown inception boundary; on the other end, 5 kV marks contact angle saturation, as increasing voltage to 5.5 kV no longer appreciably reduces the contact angle. (Decreasing) After wetting at 5.5 kV, the system is brought back to lower target voltage for investigating contact angle hysteresis. As the voltage deviates from the global contact angle saturation point, the hysteresis increases. Notably, the receding contact angle is typically greater than the advancing contact angle, wherever hysteresis is pronounced. Without being bound to any particular theory or embodiment, one can observe comparatively larger variability at lower voltages than at higher voltages.

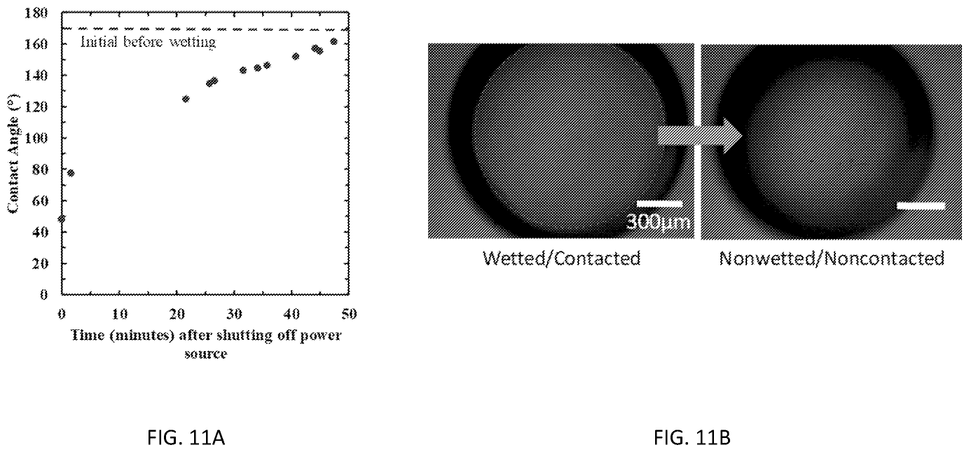

FIGS. 11A-11B show dewetting completely back to initial state by simply turning off the power source, i.e. applying 0V. As shown, the disclosed technology is reversible, as a wetted droplet returns to its unwetted state when the voltage is turned off. Dashed lines indicate contact angle prior to wetting. (FIG. 11A) Wetting ring analysis showing wetting ring (faint dashed yellow circle) at the beginning of dewetting, and the absence of wetting ring at the terminal time point indicating complete return to initial, nonwetted state. FIG. 11A shows the recovery of original contact angle after the voltage is switched off.

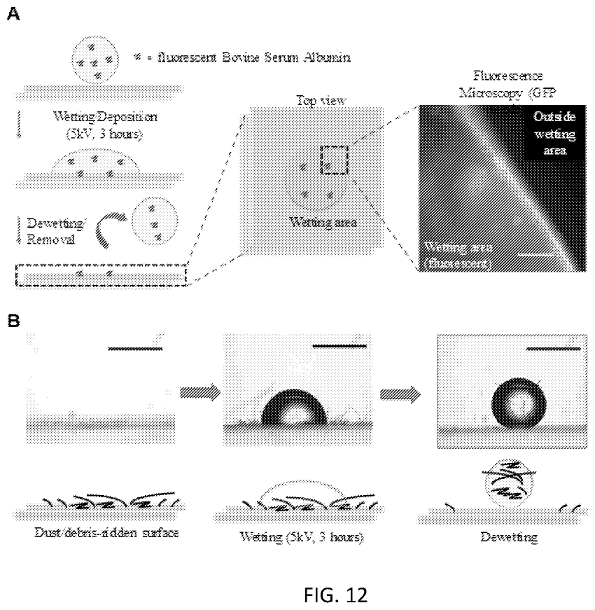

FIGS. 12A-12B provide applications of DCI towards two key modes of droplet-surface material interchange. (FIG. 12A) Material deposition: droplet containing fluorescent bovine serum albumin (fBSA) is wetted on the PDMS surface by DCI to initiate contact and deposition. A defined wetting area is formed that emits a fluorescence signal from the deposited material. Scar bar: 150 μm. (FIG. 12B) Material recovery: a pure deionized water droplet wets a dusty surface by DCI to initiate recovery of the surface debris. The droplet is dewetted and can then be further processed. Scale bar: 1.50 mm.

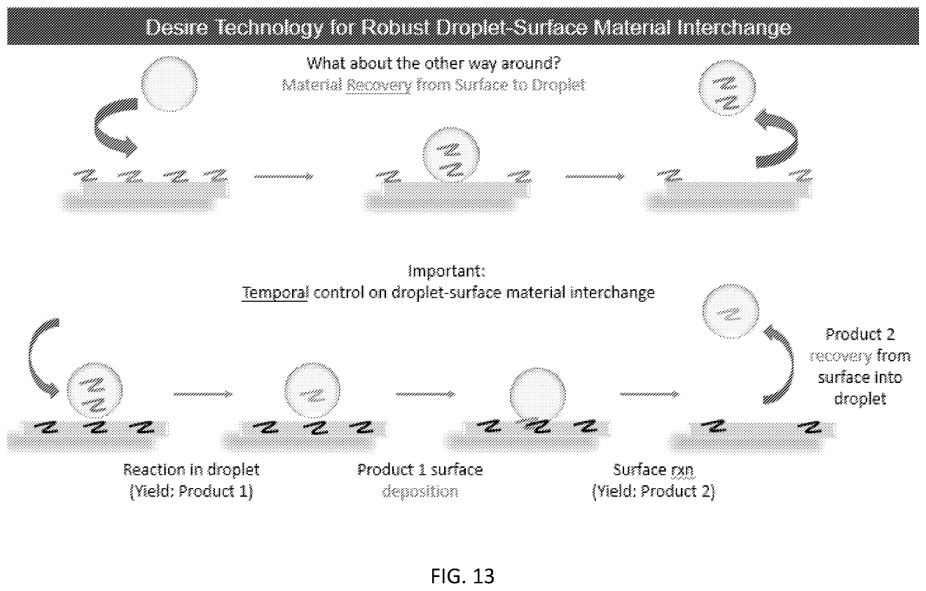

FIG. 13 provides illustrative schemes of material deposition and removal. As shown in the top line of images, material can be recovered by effecting droplet wetting on a surface that has materials (e.g., dyes, reagents, nucleic acids) disposed thereon. The droplet can be wetted (or spread) so as to contact the materials and the subsume the materials within. As shown in the bottom line of images, a droplet can accommodate a reaction (i.e., acting as a reactor). The droplet can then be wetted to a surface, and the reaction product within the droplet can then interact with material that is present on the surface, which can, in some cases, give rise to a further reaction that produces a further product that is subsumed within the droplet. The droplet (which now contains the further product) can then be recovered, e.g., by dewetting the droplet from the surface by reducing the voltage applied across the probe and target electrode (not shown).

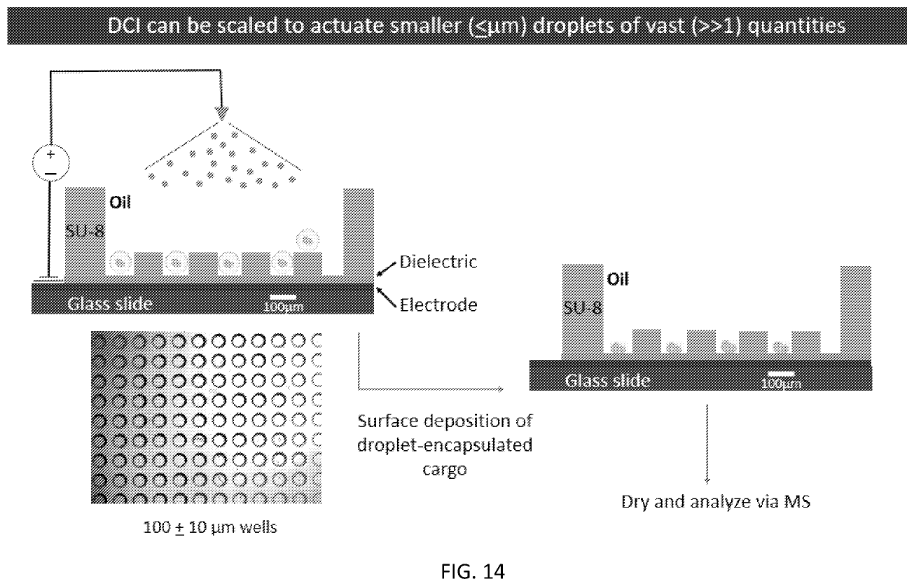

FIG. 14 shows that the disclosed technology can be used with microwell arrays, e.g., to effect wetting of one or more droplets within microwells. The wetting can be used to effect contact between the droplet and a material within the microwell. As an example, such a material can be a “barcode” (e.g., a nucleic acid sequence) that includes information about the location of the droplet (e.g., the microwell in which the droplet was disposed) and/or the composition of the droplet (e.g., the materials that were in the droplet, the materials that were in the microwell, the batch number of the droplet, and the like).

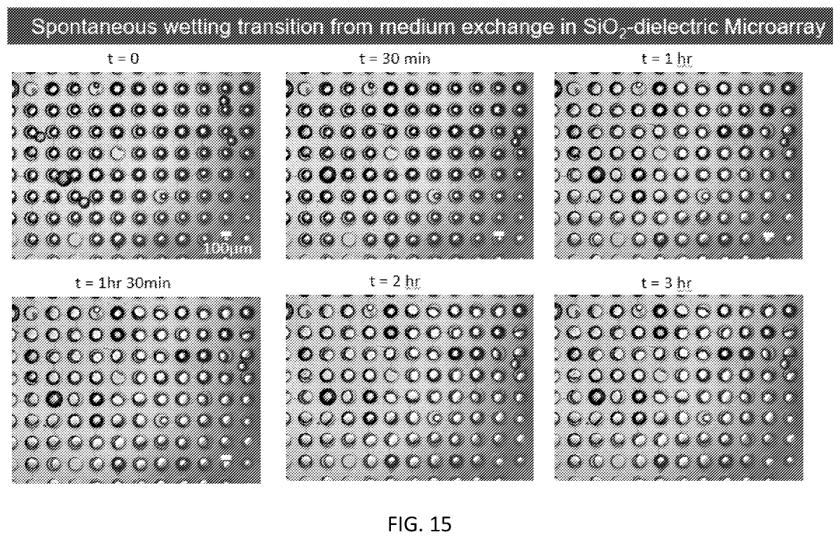

FIG. 15 provides exemplary images of spontaneous wetting transition in an array of microwells. The increase in occupied surface area and decrease in ‘dark’ areas is due to droplet curvature.

### Additional Disclosure

As mentioned, Electrowetting (EW) and electrowetting-on-dielectric (EWOD) are two traditional methods for modulating the wetting state of a droplet on a solid surface, premised on direct droplet-electrode contact to generate electric fields across the electric double layer (EW) or dielectric (EWOD). Although contactless methods that apply external physical stimuli to alter surface wetting properties have been reported, the range of contact angle modulation remains limited. Here we demonstrate a contactless method to induce reversible droplet wetting state modulation on non-wetting substrates via corona discharge-based dielectric charge injection (DCI). The method involves a sharp, conductive probe that induces dielectric breakdown of the surrounding dielectric medium under voltages exceeding the medium's dielectric strength. Breakdown leads to ionization of the dielectric, with subsequent acceleration of the generated ions away from the sharp tip due to electrostatic repulsion. This results in charge injection onto a working surface—e.g., a dielectric surface on which the droplet is situated, with an underlying reference electrode. With DCI, one induces wetting of a water droplet on a non-wetting polydimethylsiloxane (PDMS) surface immersed in hexadecane, a low dielectric liquid medium. By inducing the rupture of a thin oil film separating the droplet and the surface, DCI can induce wetting of a water droplet onto a non-wetting surface and also induce drastic contact angle modulation. Furthermore, upon removal of the voltage and/or probe, droplet undergoes dewetting and recovers the initial non-wetting state. We apply DCI to effect droplet-surface material interchange of two modes: material deposition (droplet-to-surface) and material recovery (surface-to-droplet). DCI presents a unique strategy for contactless, reversible wetting state modulation that is simple and powerful, with a wide application space that remains to be explored.

Droplet wetting state modulation allows tuning of the droplet state between non-wetting and wetting modes, and also can induce changes in the contact angle of water (or other aqueous) droplets that partially wet the surface. The ability to control the wetting state of liquid droplets can enable droplet processing in digital fluidics, tuning of liquid-liquid interface curvature in liquid lenses, and energy harvesting in reverse electrowetting (REWOD). These technologies further hinge on temporal control of wetting state modulation and reversibility of droplet wetting.

Electrowetting (EW) and electrowetting-on-dielectric (EWOD) are two traditional wetting state modulation methods that alter the Young-Dupre surface energy balance via the application of voltage, an external physical stimulus, rather than modifying the native chemical composition of the system. EW involves placing an aqueous electrolyte droplet on top of an electrode surface and applying voltage between the electrode surface and the droplet. In EWOD, a thin dielectric film is added between the droplet and electrode surface, allowing the system to tolerate higher voltages, subsequently leading to greater contact angle modulation ranges. With EWOD, operating voltages can also be modulated through the material properties of this insulating dielectric layer, particularly the dielectric constant and thickness⁶. EW and EWOD can both achieve >1000 CA change.⁷ These methods, however, may pose some challenges in inducing changes in the wetting state and contact angle of sessile droplets; for example, direct droplet-electrode contact may not be feasible with microscale droplets and a large number of droplets being actuated on surfaces.

To overcome the need for droplet-electrode contact, contactless methods to induce wetting state modulation have been developed wherein an external physical stimulus, removed from the droplet and surface, is applied to alter the surface energy state.

Thermoresponsive polymers such as poly(N-isopropylacrylamide) (PNIPAAm), for example, present a case in which heat is applied to induce changes in the contact angle of water droplets⁹. Another example is photoresponsive polymers, such as azobenzenes, where (UV) light is the applied stimulus. The change in the azobenzene properties lead to a discrete change in surface energy^{10,11}. These approaches, however, require functionalization of the surface with new chemistries that may pose challenges, especially on chemically inert dielectric surfaces.

In this work, we present an underexplored contactless approach of dielectric charge injection to induce wetting state modulation of a water droplet on a non-wetting surface in a continuous phase of apolar oil. Charge injection and electric fields have been previously employed to manipulate various interfacial phenomena.¹² Electric field pulses, generated by a common laboratory antistatic gun have shown to break and coalesce microfluidic emulsions¹³. The ability for charges and electric fields to induce various interfacial phenomena informs the design of our dielectric charge injection (DCI) as a technique for wetting state modulation. With DCI, we demonstrate the ability to contactlessly and reversibly modulate droplet wetting state with contact angle changes up to 150°, and its relevant application towards material deposition and recovery. This capability is complementary to the traditional EW/EWOD methods, with additional advantages of not requiring electrode-droplet contact, not requiring electrolytes in the aqueous droplet, and functions under a nonconducting continuous phase. This work introduces a new method of changing the wetting state of water droplets on a non-wetting surface in low dielectric media and enables a large array of water droplets for high-throughput biological and medical screenings and analyses. Here we apply these capabilities to droplet-surface material interchange, wherein temporal control allows pre-interchange processes-such as a droplet-based reaction-to reach desired levels of completion, and reversibility allows even finer temporal control on turning material interchange ‘on’ (wetting) and ‘off’ (non-wetting) at will.

One premise to temporally controllable droplet-surface material interchange via wetting state modulation lies in the initial separation of droplet and surface with a thin entrapped film of the continuous phase. This process overall can occur in two steps: (1) breaking down the thin oil film to facilitate droplet-surface contact; then (2) the wetted, contacted state is maintained along with subsequent contact angle modulation.

The present disclosure thus provides a contactless method for wetting state modulation—dielectric charge injection (DCI)—that physically tunes the wetting state of a water droplet sitting on a non-wetting surface in a nonpolar medium. In DCI, the substrate surface consists of a thin dielectric film deposited on top of an electrode surface, with the droplet situated on top of the dielectric surface—this part will be referred to as the substrate.

In this exemplary illustration, we use indium tin oxide (ITO) glass with 25 μm polydimethylsiloxane (PDMS) as the dielectric. A sharp conductor probe is brought to a defined distance from the substrate, positioned directly on top of the droplet center. The probe is connected to the positive terminal of a DC high voltage power source, while the ground terminal is connected to the ITO surface of the substrate as illustrated in FIG. 2A. A high voltage equivalent to the dielectric strength of the medium surrounding the probe is applied to induce dielectric breakdown, leading to corona discharge. The sharpness of the conductor can aid in concentrating electric field strength, which facilitates dielectric breakdown in the vicinity of the sharp tip. At breakdown, the normally nonconducting dielectric material becomes ionized, and the ions subsequently accelerate away from the like-polarity probe via electrostatic repulsion. For air, the dielectric strength is about 3 kV/mm^{16,17}. In our DCI system configuration, we demonstrate the ability to induce breakdown (≥4 kV and ambient laboratory relative humidity ˜40%) of the oil film separating the pure deionized droplet and substrate surface leading to physical contact of the water droplet with the surface, and subsequently induce up to 150° CA change, tuning the droplet all the way from a nonwetting to a highly wetting state as shown in FIG. 8B.

As the applied voltage is increased, the wetting state of the droplet begins to change (e.g., at 4 kV), at which point charge injection occurs. In one study, voltage is increased at 0.5 kV intervals for 30 seconds to 4, 4.5 and 5 kV, after which the system is held constant for 4 hours (FIG. 9A). Upon making physical contact with the surface, the droplet continues spread on the surface, leading to contact angle reduction. The contact angle decreases at all voltage levels, with a distinct discontinuity towards a new decay curve upon increasing the voltage. Alternatively, ramping up directly to and holding the voltage level directly for 3 hours shows that the contact angle decays towards an asymptotic value distinct value at each voltage level (FIG. 9B). The time scale at which each voltage level reaches the approximate asymptotic value is similar, thereby presenting a stronger driving force for wetting and spreading (i.e. contact angle change) at higher voltage levels.

Observation of the contact angle changes in FIG. 9B show that the contact angle does not necessarily saturate but continues to very slowly decrease over time, similar to the mathematical approach towards an asymptotic limit. This temporal change is reminiscent of glassy contact line aging that has been observed for colloidal particles at liquid-liquid interfaces.¹⁸. This implies approximately logarithmic time for the contact angle to reach the final, ‘saturated’ asymptotic value. Three hours is therefore elected as a feasible experimental time for which the measured contact angle is taken to be representatively close to the final asymptotic value.

In EWOD, the Lippman-Young equation describes a distinct relationship between applied voltage and apparent contact angle. FIG. 9B hints at a similar relationship existing with DCI. Investigating more intermediate voltage levels starting at 4 kV, the measured contact angle, which we define as the contact angle reached after 3 hours at a given voltage, decreases with applied voltage. with a distinct local saturation contact angle at each voltage level (FIG. 10, Increasing).

Of utility to droplet-surface material interchange is the complete global reversibility of the droplet wetting state; in other words, whether the droplet, upon wetting, can completely dewet back to the initial, nonwetted state. With DCI, the droplet wetting state is demonstrated to be reversible and is executed simply by turning off the voltage source, i.e. applying 0V (FIGS. 11A-11B). Dewetting events are also observed at non-zero voltages, especially below the breakdown inception boundary. The kinetics are tunable as there is an inflection point that occurs upon reducing the voltage from 4 kV to 2 kV. The time scale also differs quite significantly between 0V and nonzero voltage dewetting, indicating that the rate of dewetting can be controlled simply by controlling the applied voltage.

Without being bound to any particular theory, combining the insights from wetting and dewetting data (FIGS. 8A-8B and 11A-11B), a dual role of voltage can be discerned: (1) voltages exceeding dielectric strength lead to breakdown and charge injection; (2) nonzero voltages impose an electric field that inhibits charge dissipation. For the latter, this was most evident from the slower dewetting using nonzero voltages below breakdown inception compared to zero voltage. Below breakdown, there is no charge injection, and therefore the electric field present must be inhibiting dewetting via charge dissipation.

While nonwetting-wetting reversibility is a feature of interest, reversibility within the wetted state through cyclic wetting-dewetting contact angle tuning can also be useful in applications such as fine-tuning interfacial curvature in liquid lenses. Here we evaluate single cycle wetting-dewetting contact angles to evaluate such reversibility in DCI within the ion injection voltage regime (4 kV≤V≤5 kV). In EWOD, the chemical and/or topological heterogeneity of the dielectric surface contributes to irreversibility due to contact line pinning. For porous solid structures, penetration of liquids into the porous structure contribute to equivalent pinning effects. To address this pinning effect, liquid films have been developed as part of the dielectric layer to yield liquid-liquid interfaces that allow droplets to more freely wet and dewet with negligible contact line pinning, conferring robust reversibility.

To investigate this wetted state reversibility in DCI, we compare the Increasing and Decreasing contact angles at each voltage level (FIGS. 11A-11B): The Increasing contact angles are obtained by reading the contact angle after holding the target voltage for 3 hours; the Decreasing contact angles are obtained by wetting the droplet at 5.5 kV for 3 hours, then decreasing the voltage to the target value and holding for 3 hours prior to reading the resulting contact angle. At the contact angle saturation boundary (5 kV), there is virtually no difference between the Increasing and Decreasing contact angles; this is consistent with EWOD systems.

As the voltage departs from this boundary, the Decreasing contact angle is consistently higher than the Increasing contact angle at a given voltage, and the magnitude of this difference between the Increasing and Decreasing contact angles increases progressively from the contact angle saturation boundary towards the breakdown inception boundary (4 kV)—this contrasts with EWOD systems, wherein the Decreasing contact angles are observed to be consistently lower, primarily due to aforementioned contact line pinning during dewetting. At the breakdown inception boundary, where dielectric breakdown and charge injection occurs, the Decreasing contact angle consistently returns to the initial apparent contact angle—this consistency being reflected in the lower error bar magnitude.

The observed irreversibility between the two boundaries in DCI may have a basis distinct from solely surface properties. One possible explanation draws upon the charge trapping theory for dielectrics: at 5.5 kV, i.e. well within the contact angle saturation domain, excess charges injected exceeding the level that can be maintained at the surface may become trapped in the bulk dielectric layer. Upon lowering the voltage to 5 kV, charge dissipation events occur mainly from the charges that are entrapped in the bulk dielectric. The dielectric surface charge concentration remains the same for applied voltages at and beyond the contact angle saturation boundary, leading to a consistent apparent contact angle. Any surface charges that may be repelled away, due to like-polarity charges escaping from the dielectric material, get quickly replaced by those escaping charges. In contrast, at voltages below the contact angle saturation boundary, charge dissipation also occurs from the substrate surface, driven to reach a lower dielectric surface charge concentration. Moreover, charges escaping entrapment repel surface charges with less drivers for those escaping charges to replace surface charges repelled from the surface. Overall, surface charges face an additional repulsive force from escaping charges, leading to an overall lower surface charge concentration, and hence a consistently higher Decreasing contact angle.

The similarities in the voltage dependence of apparent contact angles obtained via DCI and EWOD may, without being bound to any particular theory, be an indication that the physics behind the wetting state modulation in the two methods may be similar as well. We evaluate the applicability of the Lippman-Young equation which has been developed to describe EWOD systems:

$$cos θ = cos {θ}_{0} + \frac{1}{2 γ} ( \frac{{ε}_{0} {ε}_{d}}{d} ) {V}^{2} \qquad ( 1 )$$

where θ is the contact angle with applied voltage, θ₀ is the contact angle predicted by the Young-Dupre equation in the absence of stimuli (balance of surface tensions between the surface, droplet, and continuous phases), V is the applied voltage, γ is the solid-liquid (surface-droplet) surface tension, ε₀ is the vacuum permittivity (8.854*10⁻¹² F/m)), ε_{d} is the dielectric constant of dielectric layer, and d is the thickness of the dielectric film. Mathematically, this equation cannot be used to describe the contact angle data in DCI because of order(s)-of-magnitude difference in the applied voltage range. In particular, an EWOD system of similar material configuration would be expected to reach contact angle saturation by about 400V. We also compare the voltage scaling with respect to the contact angle. While EWOD systems exhibit 0˜V², DCI shows 0˜V⁶ scaling. These analyses likely indicate that despite some of the similarities in the experimental setup and the observed phenomena, a distinct theoretical framework to describe our DCI system would be necessary.

Tying the application of DCI back to droplet-surface material interchange, DCI was applied towards material deposition (droplet-to-surface material transfer, FIG. 12A) and material recovery (surface-to-droplet material transfer, FIG. 12B). Holding all other system parameters constant, we added fluorescent bovine serum albumin (BSA) to the droplet phase and wet the droplet at 5 kV for 3 hours prior to dewetting and droplet removal. Focusing on the wetting area where droplet-surface contact occurs during wetting, fluorescence was distinguishable between the inside and outside the wetting area, the latter for which no contact and therefore no fluorescent protein deposition should occur. Qualitatively, this demonstrates the capability of depositing materials from droplet to surface. Material deposition can be useful for integrating droplet microfluidics for encapsulation of material to mass spectrometric analysis, which requires that analytes be on surfaces.

Conversely, material recovery from surface may be a capability of interest for applications such as recovery of surface reaction products for subsequent processing and/or analysis, wherein droplets are the desired medium as a compartmentalized carrier. To demonstrate this capability, DCI was applied to recover dirt/debris from a dirty surface (FIG. 12B). The surface was prepared by simply leaving exposed to the air on the lab bench for 24 hours (instead of a vacuum chamber to maintain pristine surface conditions) which resulted in accumulation of dust particles. A droplet is wetted on the surface and maintained for 3 hours prior to dewetting. The dewetted droplet visibly contains the recovered dirt/debris from the surface, demonstrating the material recovery from the surface.

Staicu et al. derived the free energy (per unit area) of the entrapped oil film as a function of film thickness in EWOD systems, reproduced below in Equation 2, which is derived from the Gibbs Equation assuming constant temperature and concentration:

$${F}_{U} ( e ) = {γ}_{os} + γ + \frac{A}{12 π {e}^{2}} - \frac{{ε}_{0} {ε}_{d} {U}^{2}}{2 d ( 1 + \frac{c {ε}_{d}}{d {ε}_{oil}} )} \qquad ( 2 )$$

where ε₀ is the permittivity of vacuum, U is the applied voltage, d is the thickness of dielectric substrate, Ea is the dielectric constant of the dielectric substrate, and εₒᵢₗ is the dielectric constant of the oil film. The free energy of this film with thickness e depends on the oil-droplet interfacial energy y and the oil-substrate interfacial energy γₒₛ as stabilizing contributions. Then there are van der Waals (vdW) interaction between the droplet and substrate, the strength of this attractive/repulsive interaction is conveyed by the sign and magnitude of the Hamaker constant A. Lastly, electrostatic energy is destabilizing, and is modeled in this equation as a parallel plate capacitor with two dielectric layers connected in series—the oil film and the dielectric substrate. A distinction between modeling film stability between EWOD and DCI is in the last term, as the first three terms are inherent to the material properties and interactions in the system; the last term portrays the destabilizing contribution of the input electric stimuli

Here we demonstrate a dielectric charge injection (DCI) technique based on corona discharge to modulate the wetting state of nonwetting droplets in an apolar liquid medium to a highly wetted state and show that this phenomenon is used to enable temporally controlled droplet-surface material interchange. Applying voltages that exceed the dielectric strength of the dielectric medium surrounding the sharp conductor probe leads to corona discharge, an event where dielectric molecules becomes ionized and accelerate away from the sharp tip due to like-polarity repulsion.

At this breakdown inception boundary, droplet transitions to a physically contacted state with the surface and further wetting modulation is observed as applied voltage is increased. DCI departs from the Lippman-Young model used to describe electrowetting-on-dielectric, with a distinctly different voltage scaling in relation to contact angle. Consistent observations of hysteresis in DCI may suggest contributions beyond the typical surface heterogeneity, particularly due to the entrapped charges in the dielectric and the dynamics of their escape/dissipation. After wetting, the droplet can be dewetted reversibly back to the initial state by simply reducing the voltage to below the breakdown inception boundary. Based on these principles, we demonstrate the use of DCI towards material deposition of fluorescent bovine serum albumin to the surface, and separately the recovery of surface debris into the droplet.

The contactless nature of DCI enables controlling droplets of various sizes, actuating large number of droplets on the surface, and assaying droplets containing electrically sensitive cargo. The reversibility of the wetting state enables one to conveniently turn the material interchange mode “on/off” and remove the droplet for subsequent processing/analysis; whereas existing methods in this domain rely on direct droplet spotting without such temporal and reversible control.

DCI, while requiring operating voltages in the kilovolts scale, possess low power consumption and therefore correspondingly low cost due to the low current required. For instance, even if applied voltage reaches as high as 25 kV, by needing current I≤0.05 mA, the power requirement is as low as <1.25 W. DCI confers additional advantages of being nonthermal and nonchemical with relatively accessible setup and operational technicality¹⁴. These factors are useful for scaling, commercialization, and robust, flexible system design for numerous alternative applications yet to be explored.

### EXPERIMENTAL SECTION

Substrate Preparation: The electrode surface is formed using an indium tin oxide (ITO) glass (resistance 70-100Ω) from Delta Technologies. A small piece of tape is used to isolate an edge region of the glass. Polydimethylsiloxane (PDMS; Sylgard 184), the dielectric material, was prepared using a 10:1 elastomer-to-crosslinker ratio, mixed thoroughly for one minute, then degassed under vacuum. A 25 μm layer of PDMS is spin coated onto ITO at 3000 rpm for 30s. A wire is connected to the isolated and exposed ITO area of the substrate, which then connects to the ground terminal of the DC power source (Matsusada Precision, AMT-20B10, Japan).

Droplet Actuation via Dielectric Charge Injection: The setup is as shown in FIG. 7. The substrate is mounted onto a flat-surfaced stand (<1° tilt) in a glass chamber.

The continuous phase, hexadecane, is prepared by mixing with alumina to remove any surfactant impurities²⁴ then filtered through a 2 μm membrane to remove any dust and debris. Hexadecane (99%, Sigma-Aldrich) is filled in the glass chamber until a desired depth relative to electrode surface, which is fixed here at 5 mm. A 2 μL deionized water droplet (resistivity 18.2 MΩ cm; filtered through 2 μm membrane) is pipetted onto the substrate surface. A sharp stainless steel probe is connected to the positive electrode of the DC power source and positioned on top of the pipetted droplet, at a height of 10 mm above the substrate surface. Voltages from 4-5.5 kV are applied for charge injection to occur in this system configuration. The droplet is viewed and contact angle measured using a goniometer (KSV Instruments) in sessile drop mode.

Material Deposition via DCI-induced Droplet Actuation: A droplet containing 11 mg/mL fluorescent bovine serum albumin conjugated with the fluorophore Alexa 488 (ThermoFisher) was applied to the same system configuration as outlined in the previous section. The system was held at 5 kV for 3 hours, then allowing the droplet to dewet at 0V for 3 hours. The droplet is removed from the surface by tilting the surface and allowing the droplet to roll off. The wetting area is then visualized under a fluorescence microscope in GFP mode (excitation: 488-490 nm, emission: 525 nm).

Material Recovery via DCI-induced Droplet Actuation: The outlined substrate preparation procedures were followed, except instead of storing in a vacuum chamber to minimize ambient dust, the substrate is left on the lab bench open to air for 48 hours to intentionally create a dusty surface. The droplet is pipetted in areas that are particularly dusty. The recovery of surface dust into droplet through wetting state modulation is visualized directly using the goniometer.

### REFERENCES

(1) Mesbah, K.; Thai, R.; Bregant, S.; Malloggi, F. DMF-MALDI: Droplet Based Microfluidic Combined to MALDI-TOF for Focused Peptide Detection. Sci. Rep. 2017, 7 (1), 6756. https://doi.org/10.1038/s41598-017-06660-8.
(2) Heinemann, J.; Deng, K.; Shih, S. C. C.; Gao, J.; Adams, P. D.; Singh, A. K.; Northen, T. R. On-Chip Integration of Droplet Microfluidics and Nanostructure-Initiator Mass Spectrometry for Enzyme Screening. Lab. Chip 2017, 17 (2), 323-331. https://doi.org/10.1039/C6LC01182A.
(3) Han, S. H.; Choi, Y.; Kim, J.; Lee, D. Photoactivated Selective Release of Droplets from Microwell Arrays. ACS Appl. Mater. Interfaces 2020, 12 (3), 3936-3944. https://doi.org/10.1021/acsami.9b17575.
(4) Staicu, A.; Mugele, F. Electrowetting-Induced Oil Film Entrapment and Instability. Phys. Rev. Lett. 2006, 97 (16), 167801. https://doi.org/10.1103/PhysRevLett.97.167801.
(5) Quilliet, C.; Berge, B. Investigation of Effective Interface Potentials by Electrowetting. Europhys. Lett. EPL 2002, 60 (1), 99-105. https://doi.org/10.1209/epl/i2002-00325-6.
(6) Moon, H.; Cho, S. K.; Garrell, R. L.; Kim, C.-J. “CJ.” Low Voltage Electrowetting-on-Dielectric. J. Appl. Phys. 2002, 92 (7), 4080-4087. https://doi.org/10.1063/1.1504171.
(7) Vo, Q.; Su, H.; Tran, T. Universal Transient Dynamics of Electrowetting Droplets. Sci. Rep. 2018, 8 (1), 836. https://doi.org/10.1038/s41598-018-19167-7.
(8) Urabe, G.; Katagiri, T.; Katsuki, S. Intense Pulsed Electric Fields Denature Urease Protein. Bioelectricity 2020, 2 (1), 33-39. https://doi.org/10.1089/bioe.2019.0021.
(9) Ma, D.; Chen, H.; Shi, D.; Li, Z.; Wang, J. Preparation and Characterization of Thermo-Responsive PDMS Surfaces Grafted with Poly(N-Isopropylacrylamide) by Benzophenone-Initiated Photopolymerization. J. Colloid Interface Sci. 2009, 332 (1), 85-90. https://doi.org/10.1016/J.jcis.2008.12.046.
(10) Kumar, A. S.; Ye, T.; Takami, T.; Yu, B.-C.; Flatt, A. K.; Tour, J. M.; Weiss, P. S. Reversible Photo-Switching of Single Azobenzene Molecules in Controlled Nanoscale Environments. Nano Lett. 2008, 8 (6), 1644-1648. https://doi.org/10.1021/n1080323+.
(11) Pei, X.; Fernandes, A.; Mathy, B.; Laloyaux, X.; Nysten, B.; Riant, O.; Jonas, A. M. Correlation between the Structure and Wettability of Photoswitchable Hydrophilic Azobenzene Monolayers on Silicon. Langmuir 2011, 27 (15), 9403-9412. https://doi.org/10.1021/la201526u.
(12) Jia, Y.; Huang, R.; Lan, Y.; Ren, Y.; Jiang, H.; Lee, D. Reversible Aggregation and Dispersion of Particles at a Liquid-Liquid Interface Using Space Charge Injection. Adv. Mater. Interfaces 2019, 1801920. https://doi.org/10.1002/admi.201801920.
(13) Karbaschi, M.; Shahi, P.; Abate, A. R. Rapid, Chemical-Free Breaking of Microfluidic Emulsions with a Hand-Held Antistatic Gun. Biomicrofluidics 2017, 11 (4), 044107. https://doi.org/10.1063/1.4995479.
(14) K S Narayanan, S. S.; Wang, X.; Paul, J.; Paley, V.; Weng, Z.; Ye, L.; Zhong, Y. Disinfection and Electrostatic Recovery of N95 Respirators by Corona Discharge for Safe Reuse. Environ. Sci. Technol. 2021, 55 (22), 15351-15360. https://doi.org/10.1021/acs.est.1c02649.
(15) Belevtsev, A. A. Modern Theory of Corona Discharge. In [1991]Proceedings of the 3rd International Conference on Properties and Applications of Dielectric Materials; 1991; pp 820-823 vol. 2. https://doi.org/10.1109/ICPADM.1991.172193.
(16) Rigden, J. S. Macmillan Encyclopedia of Physics; Simon & Schuster Macmillan: New York, 1996.
(17) Peek, F. W. (Frank W. Dielectric Phenomena in High-Voltage Engineering; New York [etc.] McGraw-Hill Book Company, inc., 1929.
(18) Kaz, D. M.; McGorty, R.; Mani, M.; Brenner, M. P.; Manoharan, V. N. Physical Ageing of the Contact Line on Colloidal Particles at Liquid Interfaces. Nat. Mater. 2012, 11 (2), 138-142. https://doi.org/10.1038/nmat3190.
(19) Mark, J. E. Polymer Data Handbook (2nd Edition).
(20) Verheijen, H. J. J.; Prins, M. W. J. Reversible Electrowetting and Trapping of Charge: Model and Experiments. Langmuir 1999, 15 (20), 6616-6620. https://doi.org/10.1021/la990548n.
(21) Klarman, D.; Andelman, D.; Urbakh, M. A Model of Electrowetting, Reversed Electrowetting, and Contact Angle Saturation. Langmuir 2011, 27 (10), 6031-6041. https://doi.org/10.1021/la2004326.
(22) Di Virgilio, V.; Bermejo, S.; Castaner, L. Wettability Increase by “Corona” Ionization. Langmuir 2011, 27 (15), 9614-9620. https://doi.org/10.1021/1a2019583.
(23) Castaner, L.; Di Virgilio, V.; Bermejo, S. Charge-Coupled Transient Model for Electrowetting. Langmuir 2010, 26 (20), 16178-16185. https://doi.org/10.1021/la102777m.
(24) Nguyen, T. M. T.; Do, T. P. T.; Hoang, T. S.; Nguyen, N. V.; Pham, H. D.; Nguyen, T. D.; Pham, T. N. M.; Le, T. S.; Pham, T. D. Adsorption of Anionic Surfactants onto Alumina: Characteristics, Mechanisms, and Application for Heavy Metal Removal. Int. J. Polym. Sci. 2018, 2018, 1-11. https://doi.org/10.1155/2018/2830286.

### Aspects

The following Aspects are illustrative only and do not limit the scope of the present disclosure or the appended claims.
Aspect 1. A method of modulating the contact angle of a droplet, comprising: applying a voltage across a probe disposed in a first medium and a target electrode so as to give rise to ions in the first medium that are encouraged away from the probe and toward the target electrode, the probe being configured such that the probe does not physically contact the droplet, the droplet being disposed between (1) the probe and (2) a dielectric surface located between the probe and the target electrode, and the ions being effective to decrease a contact angle of the droplet relative to the surface.
Aspect 2. The method of Aspect 1, wherein the first medium is air.
Aspect 3. The method of any one of Aspects 1-2, wherein the droplet is disposed in the first medium.
Aspect 4. The method of Aspect 1, wherein the droplet is disposed in a second medium.
Aspect 5. The method of Aspect 4, wherein the droplet and the second medium are immiscible with one another.
Aspect 6. The method of Aspect 4, wherein the droplet has a density, wherein the second medium has a density, and wherein the density of the droplet differs from the density of the second medium.
Aspect 7. The method of any one of Aspects 4-6, wherein the second medium is an oil. An oil can be, e.g., a silicone oil or a mineral oil. A variety of oils can be used, including (but not limited to) hexadecane. The second medium can be nonpolar and/or nonconducting. The second medium can be selected based on its vapor pressure; a user may elect to use a second medium (e.g., hexadecane) that has a comparatively high vapor pressure on the ground that such a medium evaporates only slowly over time. This can have the advantage of maintaining the depth of the medium over relatively long periods of time, although this is not a requirement.
Aspect 8. The method of Aspect 7, wherein the oil comprises hexadecane.
Aspect 9. The method of any one of Aspects 1-8, wherein the droplet is essentially free of electrolytes.
Aspect 10. The method of any one of Aspects 1-9, wherein the droplet comprises therein a nucleic acid, an oligo-nucleotide, a peptide, a biomolecule, a component of a biomolecule, a cell, a group of cells, an organoid, a fabricated bead, a solid particle, a small molecule analyte or reagent, or any combination thereof. As but one example, an active pharmaceutical ingredient (API) can be comprised within a droplet.
Aspect 11. The method of any one of Aspects 1-10, further comprising varying the voltage, the voltage optionally being varied according to a schedule. A voltage can be varied in an automated fashion, e.g., increased to achieve a pre-set value at which a certain degree of droplet wetting is achieved. Voltage application can be controlled automatically, e.g., as a function of time, as a function of visual observation of a given droplet or droplets, and the like.
Aspect 12. The method of any one of Aspects 1-11, wherein the voltage is applied so as to (1) decrease the contact angle of the droplet such that the droplet contacts a material disposed on the surface, at least a portion of which material is then subsumed within the droplet, (2) decrease the contact angle of the droplet such that the droplet contacts another droplet, or both (1) and (2).
Aspect 13. The method of Aspect 12, wherein the material is indicative of a location of the droplet, a composition of the droplet, or both. Such a material can be used to denote a region of a substrate, e.g., placement of a dye or other material on a region of a substrate such that a droplet that contacts the marked region of the substrate will take up some of the marker, thereby showing that the droplet contacted the marked region of the substrate. Likewise, the material can be a material that is reactive with one or more components of the droplet, which reaction can provide evidence that the droplet contacted the region of the surface (substrate) where the material was located.
Aspect 14. The method of any one of Aspects 12-13, wherein the material is reactive with a component of the droplet. As but one example, when the surface has disposed thereon an additional active material, (e.g., a nucleic acid, an oligo-nucleotide, a peptide, a biomolecule, a component of a biomolecule, a cell, a group of cells, an organoid, a fabricated bead, a solid particle, a small molecule analyte or reagent, or any combination thereof), a decrease in contact angle (and the attendant wetting) can place the droplet into contact with the additional material so as to effectively deliver the material to the droplet or vice versa.

As but one example, the disclosed methods can be performed so as to effect heterogeneous catalysis, a catalytic reaction wherein the reagents are (typically) in the liquid phase and the catalyst is on the solid surface; in such systems the catalyst is essential for the reaction to proceed at a suitable acceptable time scale, e.g., a technologically desirable rate. In this way, catalyst can be present on the dielectric surface, and the wetting of the droplet can be effected so as to contact the droplet and the catalyst. As another example, one can place an enzyme on the surface, which enzyme can then participate in a biological heterogeneous catalysis with a droplet. One can, for example, perform a DNA amplification reaction using the DNA polymerase enzyme, with the enzyme being placed on the surface and the necessary reagents in the droplet and/or placed on the surface.
Aspect 15. The method of any one of Aspects 1-14, further comprising reducing the voltage so as to increase a contact angle of the droplet relative to the substrate.
Aspect 16. The method of any one of Aspects 1-15, wherein the substrate is characterized as planar. This is not a requirement, however, as the substrate can be curved, ridged, corrugated, or otherwise non-planar in some respect.
Aspect 17. The method of any one of Aspects 1-16, wherein the droplet is disposed within a depression of the substrate. As shown and described herein, a substrate can define one or more wells or other depressions. A substrate can also include, e.g., one or more channels between wells such that induced wetting of a droplet within a given well can cause the droplet (or a portion thereof) to flow through a channel from the given well to another well joined by the channel to the given well.
Aspect 18. The method of any one of Aspects 1-17, further comprising effecting deposition of a material from the droplet onto the substrate.
Aspect 19. The method of any one of Aspects 1-18, further comprising recovering the droplet after a change in the contact angle of the droplet relative to the substrate.
Aspect 20. A system, comprising: a probe; a voltage source, the voltage source being in electronic communication with the probe; a target electrode; a dielectric substrate (e.g., a dielectric surface) disposed between the probe and the target electrode, the system being configured such that the voltage source is operable to give rise to ions in first medium surrounding the probe that are encouraged away from the probe and toward the target electrode while the probe is free of physical contact with a droplet that has a density and is disposed between (1) the probe and (2) the dielectric substrate, the system being further configured such that the ions are sufficient to effect a decrease in a contact angle of the droplet relative to the dielectric substrate.

As described elsewhere herein, in a system where the droplet is aqueous and is present in a hydrophobic (e.g., oil) medium, application of voltage can give rise to a decrease in the contact angle of the droplet with the dielectric substrate surface. In an inversion of this scenario, e.g., where the droplet is an oil droplet in an aqueous medium (or other medium that is more polar relative to the droplet), application of voltage (and an attendant injection of ions) can (without being bound to any particular theory or embodiment) lead to an increase in the droplet's contact angle relative to the substrate/surface.
Aspect 21 The system of Aspect 20, further comprising a second medium, the second medium being disposed so as to enclose the droplet.
Aspect 22. The system of Aspect 21, wherein the second medium has a density lower than the density of the droplet.
Aspect 23. The system of any one of Aspects 20-21, wherein the second medium is an oil.
Aspect 24. The system of any one of Aspects 20-23, further comprising a material disposed on the substrate.
Aspect 25. The system of Aspect 24, wherein the material is positioned such that the decrease in the contact angle of the droplet relative to the substrate effects contact between the droplet and the material.
Aspect 26. The system of any one of Aspects 24-25, wherein the material is indicative of a position of the droplet, a composition of the droplet, or both.
Aspect 27. The system of any one of Aspects 24-26, wherein the material is reactive with a component of the droplet.
Aspect 28. The system of any one of Aspects 20-27, wherein the voltage source is operable according to a programmed schedule.
Aspect 29. The system of any one of Aspects 20-28, wherein the voltage source is operable to vary a voltage applied to the probe. The voltage can be varied in a linear fashion, but this is not a requirement.
Aspect 30. The system of any one of Aspects 20-29, wherein the dielectric substrate defines at least one depression, the at least one depression being configured to accommodate the droplet.

1. A method of modulating the contact angle of a droplet, comprising:
applying a voltage across a probe disposed in a first medium and a target electrode so as to give rise to ions in the first medium that are encouraged away from the probe and toward the target electrode,
the probe being configured such that the probe does not physically contact the droplet,
the droplet being disposed between (1) the probe and (2) a dielectric surface located between the probe and the target electrode, and
the ions being effective to decrease a contact angle of the droplet relative to the surface.

2. The method of claim 1, wherein the first medium is air.

3. The method of claim 1, wherein the droplet is disposed in the first medium.

4. The method of claim 1, wherein the droplet is disposed in a second medium.

5. The method of claim 4, wherein the droplet and the second medium are immiscible with one another.

6. The method of claim 4, wherein the droplet has a density, wherein the second medium has a density, and wherein the density of the droplet differs from the density of the second medium.

7. The method of claim 4, wherein the second medium is an oil.

8. The method of claim 7, wherein the oil comprises hexadecane.

9. The method of claim 1, wherein the droplet is essentially free of electrolytes.

10. The method of claim 1, wherein the droplet comprises therein a nucleic acid, an oligo-nucleotide, a peptide, a biomolecule, a component of a biomolecule, a cell, a group of cells, an organoid, a fabricated bead, a solid particle, a small molecule analyte or reagent, or any combination thereof.

11. The method of claim 1, further comprising varying the voltage, the voltage optionally being varied according to a schedule.

12. The method of claim 1, wherein the voltage is applied so as to (1) decrease the contact angle of the droplet such that the droplet contacts a material disposed on the surface, at least a portion of which material is then subsumed within the droplet, (2) decrease the contact angle of the droplet such that the droplet contacts another droplet, or both (1) and (2).

13. The method of claim 12, wherein the material is indicative of a location of the droplet, a composition of the droplet, or both.

14. The method of claim 12, wherein the material is reactive with a component of the droplet.

15. The method of claim 1, further comprising reducing the voltage so as to increase a contact angle of the droplet relative to the substrate.

16. The method of claim 1, wherein the substrate is characterized as planar.

17. The method of claim 1, wherein the droplet is disposed within a depression of the substrate.

18. The method of claim 1, further comprising effecting deposition of a material from the droplet onto the substrate.

19. The method of claim 1, further comprising recovering the droplet after a change in the contact angle of the droplet relative to the substrate.

20. A system, comprising:
a probe;
a voltage source, the voltage source being in electronic communication with the probe;
a target electrode;
a dielectric substrate disposed between the probe and the target electrode, the system being configured such that the voltage source is operable to give rise to ions in first medium surrounding the probe that are encouraged away from the probe and toward the target electrode while the probe is free of physical contact with a droplet that has a density and is disposed between (1) the probe and (2) the dielectric substrate,
the system being further configured such that the ions are sufficient to effect a decrease in a contact angle of the droplet relative to the substrate.

21. The system of claim 20, further comprising a second medium, the second medium being disposed so as to enclose the droplet.

22. The system of claim 21, wherein the second medium has a density lower than the density of the droplet.

23. The system of claim 20, wherein the second medium is an oil.

24. The system of claim 20, further comprising a material disposed on the substrate.

25. The system of claim 24, wherein the material is positioned such that the decrease in the contact angle of the droplet relative to the substrate effects contact between the droplet and the material.

26. The system of claim 24, wherein the material is indicative of a position of the droplet, a composition of the droplet, or both.

27. The system of claim 24, wherein the material is reactive with a component of the droplet.

28. The system of claim 20, wherein the voltage source is operable according to a programmed schedule.

29. The system of claim 20, wherein the voltage source is operable to vary a voltage applied to the probe.

30. The system of claim 20, wherein the dielectric substrate defines at least one depression, the at least one depression being configured to accommodate the droplet.
